(19) United States
(12) Patent Application Publication
(10) Pub. No.: US 2026/0091950 A1
(43) Pub. Date: Apr. 2, 2026

(54) METHOD AND APPARATUS FOR MAKING ADHESIVE TAPE

(71) Applicants: Rene RAMBUSCH, Wuppertal (DE); Timo LEERMANN, Wuppertal (DE)

(72) Inventors: Rene RAMBUSCH, Wuppertal (DE); Timo LEERMANN, Wuppertal (DE)

(21) Appl. No.: 19/334,134

(22) Filed: Sep. 19, 2025

(30) Foreign Application Priority Data
Sep. 27, 2024 (EP) 24203238.1

(51) Int. Cl. B65H 35/02; C09J 7/21; C09J 7/35

(52) U.S. Cl. CPC B65H 35/02; C09J 7/21; C09J 7/35; B65H 2511/16

(57) ABSTRACT

A method of making adhesive tape has a step of first feeding a textile substrate band formed of thermoplastic fibers or filaments from a supply roll in a longitudinal direction. Then at least one longitudinally extending track where the fibers or filaments are melted together and a thickness of the band is reduced is formed in the band. The band formed with the track is thereafter cut into longitudinal strips by longitudinally severing the band at the track with a longitudinal slitter having at least one blade.

### FIELD OF THE INVENTION

The present invention relates to a method and apparatus for making adhesive tape. More particularly this invention concerns adhesive tape used to bundle cable.

### BACKGROUND OF THE INVENTION

Such a tape typically is formed from a textile substrate band optionally having an adhesive coating is fed from a supply roll in a longitudinal direction and is cut into longitudinal strips by a longitudinal slitter. This longitudinal slitter has at least a cutting wheel, and a heatable fuser is provided that can melt the cut edges of the adhesive tapes.

The textile substrate band is typically cut into longitudinal strips to make adhesive tapes. For this purpose the individual adhesive tapes are wound into rolls and then packaged. The textile substrate band can in this context be provided with the adhesive coating on one or both faces and then cut lengthwise. There is also the possibility of first cutting the textile substrate band without adhesive coating lengthwise and then providing the individual longitudinal strips with the adhesive.

This basic procedure is described by way of example in applicant's DE 10 2020 119 494. There, the textile substrate band and/or its longitudinal strips are stored. The procedure described has proven itself in principle.

The formation of longitudinal cuts using the longitudinal slitter and the appearance of the longitudinal strips from the textile substrate band are however under circumstances problematic with respect to the cut edges of the adhesive tapes manufactured in this way. In fact the cut edges here have the problem that so-called fraying can be observed. In addition, fuzz or thread formation, for example if sewn backings are processed in the described way and manner. Such fraying or the thread or fuzz formation occur naturally with nontextile substrate bands as a rule but not, for example, if plastic films are used.

For this reason the prior-art starting-point technology according to the DE 10 2023 105 349 is such that in addition to the roller cutting blade as a component of the longitudinal slitter there is also a heatable fuser. This fuser serves to melt and fuse together the cut edges of the adhesive tapes produced with the aid of the roller cutting blade.

To this end details are described whereby the cut edge of the adhesive tapes after the cutting is thermally heated with the aid of a fusing tool such that the fibers and/or filaments forming the textile are at least partially melted. This forms welds between the fibers and/or filaments. The fusing tool is a comb-like device with heated prongs that dip between the longitudinal strips. This causes the substrate band, which is divided into the longitudinal strips with its previously generated cut edges engaging the individual heated tines of the comb-like fusing tool to undergo the described fusing of the cut edges.

The described procedure may generally provide for a fusing of the produced cut edges. However, the technological and production-related effort is great and not very flexible. In fact the comb-like prongs cannot be changed with regard to their spacing, so that the processing of textile substrate bands with different widths of the adhesive tapes produced in this way is not possible. Rather, each desired adhesive tape width ultimately requires its own specially designed fusing tool.

In addition, the fusing takes place after and downstream of the longitudinal cutting. This places high requirements on the guidance of the previously produced longitudinal strips or adhesive tapes with their cut edges in comparison to the fusing tool. I.e., the previously used roller cutting blades forming the longitudinal strips must be guided exactly in such a way that they run into the gaps between the tines and are guided with their cutting edges along the tines. This requires a special belt guide, which also, like the fusing tools as such, is technologically complex and accordingly expensive and with little flexibility. This is addressed by the invention.

### OBJECTS OF THE INVENTION

It is therefore an object of the present invention to provide an improved method and apparatus for making adhesive tape. Another object is the provision of such an improved method and apparatus for making adhesive tape that overcomes the above-given disadvantages, in particular where the technological effort is reduced and the production costs are reduced.

In addition, flexible production of adhesive tapes with different widths must possible well as a suitable apparatus for carrying out the method.

### SUMMARY OF THE INVENTION

A method of making adhesive tape comprises first feeding a textile substrate band formed of thermoplastic fibers or filaments from a supply roll in a longitudinal direction. Then at least one longitudinally extending track where the fibers or filaments are melted together and a thickness of the band is reduced is formed in the band. The band formed with the tracks is thereafter cut by longitudinal slitter having at least one blade into longitudinal strips by longitudinally severing the band at the track.

Thus for attaining the object of the invention one starts from a generic method of making an adhesive tape but with the fuser upstream of and effective before the roller cutting blade to form in the substrate band a melted track that is cut through by the downstream roller cutting wheel.

According to the invention and in contrast to the generic state of the art according to DE 10 2023 105 349 the fuser is upstream of and/or acts on the band before the roller cutting blade, whereas in the known prior art the fuser is downstream of and acts on the band after the roller cutting blade. Due to this positioning and temporal succession, the previously outlined disadvantages are avoided, namely essentially the increased technological effort and the lack of flexibility. Both disadvantages have been overcome by the invention.

Because the fuser is upstream of and effective before the roller cutting blade, no subsequent fusing of the cut edges takes place. Rather, this fusing takes place as it were preliminarily and before the cuts are made in the textile substrate band. The cutting follows with the help of the melted track in the substrate band.

In fact here the fuser ensures the formation of the melted track in the substrate band. In this context the fuser ensures that the substrate band is thermally heated in the area of this melted track to the extent that the fibers and/or filaments forming the textile are at least partially melted together. This forms thermal welds and thus as it were a solidified area, which is the melted track, of the textile substrate band. This melted track runs in the longitudinal direction of the substrate band and indeed in the area where the substrate band is cut through with the help of the downstream and subsequently effective roller cutting blades. This is ensured by movement of the substrate band in the longitudinal direction while the slitter and the fuser remain stationary.

For this reason the longitudinally transported substrate band is formed with so many longitudinally extending melted tracks parallel to each other as subsequently cut edges are produced, in order to be able to in this way make the longitudinal strips and thus the adhesive tapes. For this purpose the melted tracks each have a track width that on the one hand enables a perfect cut in this solidified area of the substrate band using the roller cutter and on the other hand ensures that, after the cut, the longitudinal strips formed in this way are fused at the cut edges, because the cut edges are formed according to the invention by cutting through the melted track generally in its center.

In doing so, the roller cutting blades typically cut through the melted track in question with a crush cut. For this purpose conventional rollers cutting wheels, for example such as described in of DE 103 05 874 in principle can be used.

In fact one here typically uses driven rotating blades with a triangular cutting edge to cut through the melted track generally in the middle. For this purpose the textile substrate band is generally guided over a counter-rotating pressure roller that can for example have a rubber coating, but usually does not.

In this method the textile substrate band with its back face free of an adhesive coating is typically provided with the melted tracks that are then cut through using the roller cutting blades generally in the middle. For this purpose the melted track has a predetermined width that can generally be 1 mm and more. Smaller widths of the melted track of less than 1 mm are also conceivable, as long as the required longitudinal cut can subsequently be made in the melted track and the longitudinal edges thus produced are fused.

In most cases here track widths of the melted track of for example 1 to 3 mm and more are used. Also widths of the melted track from 3 to 5 mm and more can be set. Furthermore, the design is made in such a way that the textile substrate band consists of at least 50% by weight of plastic. This can be realized in detail in such a way and implemented in that the textile substrate band is basically a laminate composed for example of a fabric or nonwoven fabric and a plastic coating. In such a method one will meet the design in general in such a way that in this case the back face of the textile woven or nonwoven band is formed with the melted track, whereas the plastic coating on the opposite front face is provided with the adhesive coating.

When now the melted track is formed in the fabric or fleece, primarily the also plastic coating located underneath ensures that it solidifies in the area of the melted track because in this case mainly the plastic of the plastic coating is melted, so that the desired solidified areas are formed and thus create the melted track. This all happens as it were automatically in that the fuser as well as the roller cutting blades are fixed and in contrast the textile substrate band moves longitudinally thereon.

In most cases, however, the textile substrate band in the context of the invention is not a laminate of for example a textile substrate band and a plastic coating, although that is in principle also possible. Rather the textile substrate band is characterized according to the invention in that here typically at least one or several textile layers are used. In order to obtain in this context the necessary fusibility for the formation of the melted track, the design is thereby such that the textile substrate band in question in this case is composed of at least 50% by weight of plastic fibers and/or plastic filaments. The fuser therefore ensures that the plastic fibers and/or plastic filaments in the substrate band are only heated to such an extent that they melt at least in the area of the melted track and form the previously already mentioned thermal welds between the plastic fibers and/or plastic filaments.

A consequence of this is that the plastic fibers and/or plastic filaments melt at least to a partial thickness of the substrate band in comparison to the total thickness and melt together at the melted track, forming a thin, dense, and welded-together mass at the track. This partial thickness is at least 20% and in particular at least 50% of the total thickness of the substrate band.

The fuser therefore ensures that the plastic fibers and/or plastic filaments are at least partially melted and welded together in the area of the melted track. As a result the already mentioned welds are formed and consequently form a solidified area of the substrate band. This solidified area not only has a certain track width of the thus made melted track, but at the same time the solidified area has a track depth that corresponds to the partial thickness of the substrate band in comparison to the total thickness. In this track depth the plastic fibers and/or plastic filaments are fused together. The track depth and the partial thickness of the substrate band connected thereto in comparison to the total thickness is at least 20% and more, regularly 50% and more of the total thickness.

According to the invention the melted track and the solidified area defined thereby together reduce the total thickness of the substrate band and have a track depth equal to at least 20% and more of the total thickness. This ensures that the substrate band can be cut cleanly in the area of the melted track and that the cut edges formed in this way show no fraying, lint formation or thread formation.

However, in general the melted track leads to a consolidation of the substrate band under consideration of the track width and a track depth set with the aid of the fuser, which generally corresponds to less than the total thickness of the substrate band. In this case, the melted track therefore extends through most of the thickness of the substrate band, with all of the fibers or filaments between the floor of the groove formed by the track and the back face compacted and welded together. This ensures that the subsequently produced cut edges do not fray or have thread formation or other deficiencies also over their entire width. This is the essentially advantageous.

According to a further advantageous embodiment, the fuser and the roller cutting blade can define a functional unit. Thus, the fuser and the roller cutting blade are for example fixed to a common support. This ensures from the outset their mutual alignment and additional measures for alignment are not required.

In fact this ensures that the upstream fuser defines the melted track in the longitudinal direction and subsequently the roller cutting blade cuts through the melted track for the most part centrally, whereby as a result of the width or track width of the melted track at the same time the cut edges are also fused. Fraying, thread or fiber formation in the area of the cut edges does therefore not occur.

It may but also be that the fuser and the slitting blade are functionally separate from each other. In this case the textile substrate band is first treated with the fuser and the one or the several melted tracks are formed. This takes place generally on the back face of the substrate band, thus on the face not provided with the adhesive coating. If no adhesive coating is applied at this time, the textile substrate band can of course also be provided on both faces with melted tracks.

In any case, this functional separation between the fuser and the slitting blade first ensures that the melted track is introduced into the textile substrate band that can then be wound up. In a later or downstream step then the textile substrate band can be cut at the melted track or the several melted tracks in the longitudinal direction. For this purpose the textile substrate band with the relevant melted tracks is unwound and fed to the one or the several slitting wheels. In this context the slitting blades are aligned with respect to the melted tracks with the aid of a sensor or vice versa. The sensor thus ensures that the slitting blade on the one hand “hits” the respective melted track and on the other hand each melted track is also actually cut in the middle using the respective slitting blade.

For this purpose the sensor can scan the melted track. This takes place for example optically with the help of a camera and by image comparison. Of course, other scanning options are also conceivable, for example tactile, by moving a scanner over the substrate band and detecting the melted track as a particularly “smooth” area. Furthermore it is naturally within the scope of the invention for the sensor also then to realize and to implement if the fuser and the slitter define the functional unit.

As already explained, the textile substrate band is at least largely made of plastic fibers and/or plastic filaments or plastic threads. In fact a textile substrate band of at least 50% by weight plastic is used. Here there is also still the further possibility that in addition to the plastic fibers and/or plastic filaments also for example natural fibers can be used. With the aid of the procedure according to the invention, in principle also, the textile substrate bands can be treated and cut that are composed of natural fibers and plastic fibers, as long as the proportion of the synthetic fibers in the example is more than 50% by weight and more in relation to the mass of the textile substrate band.

The fuser works in principle in two different ways in order to form the melted track in the substrate band. In fact it is conceivable that the fuser generates the melted track with or without contact. In the method, the fuser can be heated overall above the melting point of the substrate band and in particular above the melting point of the plastic used. Contact of the fuser with the substrate band subsequently forms the melted track. In this variant, the fuser in the simplest case may be a heated bar or also a heated roller or the like. The roller may roll like the slitting blade in the longitudinal direction continuously on the substrate band or be driven. This is because the fuser is, like the slitter, typically designed to be stationary, so that longitudinal movement of the textile substrate band causes the rolling movement.

Provided that the fuser generates the melted track in the substrate band without contact, this is done generally in such a way that the fuser heats the substrate band by electromagnetic radiation above the melting point (of the plastic) and thereby produces the melted track without contact. The electromagnetic radiation used at this location is typically heat (IR radiation). It is also conceivable that the fuser uses an (IR) laser that serves for example with recourse to corresponding infrared radiation for the desired heating of the substrate band above the melting point of the plastic and thus ensures the contactless formation of the melted track. For example here a CO₂ laser can be used.

Of course combinations are possible whereby the fuser generates the melted track with or without contact. In this case for example a heated bar or a heated roll also may be combined with a laser. Also, an ultrasonic unit is in this context generally conceivable to make the melted track without cutting the textile substrate band in the substrate band.

The object of the invention is also an apparatus for making an adhesive tape, an adhesive tape produced according to the inventive method, and finally the use of the thus produced adhesive tape for wrapping of cable tapes in automobiles.

Thus a method and an associated apparatus for the production of an adhesive tape are proposed that have a strikingly simple structure and can be adjusted particularly flexibly to different desired widths of the adhesive tapes produced. Because, in contrast to the prior art with the comb-like melted track tool, the invention works completely differently and oppositely in that the substrate band is upstream of the fuser with the melted track. This can be done flexibly depending on the subsequently desired width of the adhesive tape produced in this way. Naturally, the number of adhesive strips manufactured from the textile substrate band can vary. This all succeeds technologically simply and thus cost effectively. In addition, in this context in comparison to conventional production speeds, significantly increased production speeds are observed that can be to 40 m/min, whereas one has so far observed and conventional processing speeds of only 10 m/min. The is bo be understood as only exemplary and is in no way restrictive.

### BRIEF DESCRIPTION OF THE DRAWING

The above and other objects, features, and advantages will become more readily apparent from the following description, reference being made to the accompanying drawing in which:

FIG. 1 is a basic overview of an apparatus according to the invention for making an adhesive tape and for carrying out the method according to the invention, and

FIG. 2 is a detailed view of the fuser and slitter.

### SPECIFIC DESCRIPTION OF THE INVENTION

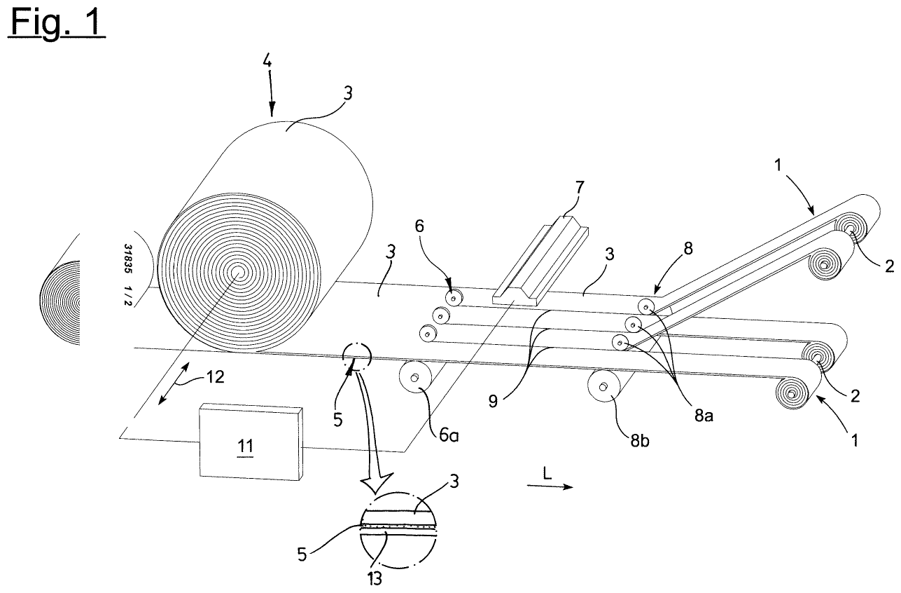

FIG. 1 shows an apparatus for making an adhesive tape 1. In fact in this embodiment four individual tapes 1 are seen on the output end of the apparatus. The adhesive tapes 1 are wound into rolls 2 and then packaged.

In order to make the adhesive tapes 1, a textile substrate band 3 is fed into the apparatus's input end from a supply roll 4. The textile substrate band 3 moves for this purpose in the longitudinal direction L shown in FIG. 1. The textile substrate band 3 is according to this embodiment a woven or a nonwoven web. Furthermore, the textile substrate band 1 can also be designed as a velour web, knitted fabric web or the like. Also, combinations are conceivable, so a substrate band 3 can be made of multiple layers of several different or also the same above-mentioned textile webs.

The textile substrate band 3 is thereby fed from the supply roll 4 in the longitudinal direction L. Here the substrate band 3 according to this embodiment but not limited thereto also has an adhesive coating 5 that was previously applied to the substrate band 3 with the aid of an unillustrated applicator. Then according to the illustrated embodiment the substrate band 3 with its back face free of the adhesive coating 5 is deflected upward generally in the longitudinal direction L as shown in FIG. 1. Here, the coating-free back face of the textile substrate band 3 according to the invention first passes through a fuser 6, then an optional sensor 7 and thereafter a longitudinal slitter 8 with several slitting blades/wheels 8a. In fact at this location three slitting wheels 8a are provided that subdivide the substrate band 3 into four individual longitudinal strips corresponding to the adhesive tapes 1 that are ultimately wound into the rolls 2.

The individual slitter wheels 8a form according to this embodiment longitudinal cuts in the form of so-called crush cuts in the substrate band 3. For this purpose the individual slitting wheels 8a bear on a counter roller 8b that can be a steel roller with a hardened surface. In addition there is the possibility that the adhesive coating 5 is covered with a so-called liner 13 in order to avoid any adhesion of the adhesive coating 5 to the counter roll 8b. This is however not a mandatory measure, but an option depending on the adhesive used for the coating 5.

It is essential for the invention that the heatable and stationary fuser 6 is provided to ensure that the cut edges subsequently produced by the also stationary slitting wheels 8a are fused. In fact the cut edges are each located case on the longitudinal edges of the adhesive tape 1. In this connection it is according to the invention of particular importance that the fuser 6 is upstream of and effective before the slitting wheels 8. As a result the fuser 6 forms melted tracks 9 in the textile substrate band 3.

One can see from the view from above of FIG. 1 that at this location the fuser 6 forms a total of three melted tracks 9 in the substrate band 3 or on its adhesive-coating-free back face. These three melted tracks 9 in the example shown correspond to where subsequently the textile substrate band 3 with the three melted tracks 9 is longitudinally cut, namely with the aid of the longitudinal slitter 8 by its three cutting wheels 8a. Subsequently, the textile substrate band 3 is fanned out downstream of the longitudinal slitter 8 into a total of four adhesive tapes 1, here two pairs of longitudinal strips that are each wound into a respective roll 2.

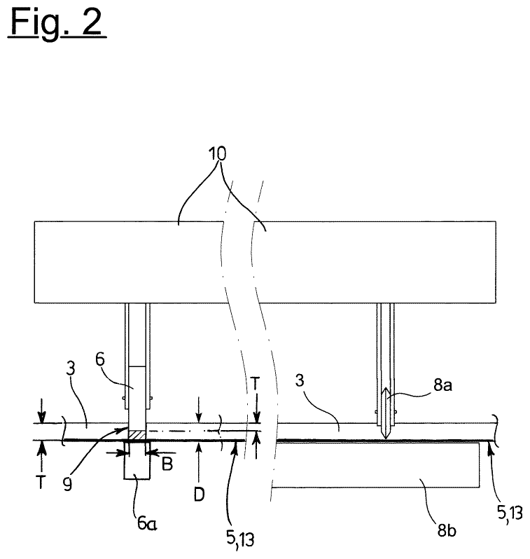

The front view in FIG. 2 shows that the fuser 6 according to this embodiment is designed as a heated bar 6 or heated roller of predetermined width B. This heated roller or according to this embodiment, heated bar 6 is stationary, like the respective slitter 8a, whereas on the other hand the textile substrate band 3 moves over it in the longitudinal direction L. This allows the fuser 6 to roll like the respective slitting wheel 8a on the textile substrate band 3 or slide along it. This may be assisted by a drive for counter rollers 8b or 6a

Since the bar 6 is heated and has the width B, the heated bar 6 generally ensures that the substrate band 3 or the plastic fibers and/or plastic filaments are at least partially melted in the area B. The fused plastic fibers and/or filaments at this location are at least partially melted there to form the melted tracks 9. Each melted track 9 produced in this way has a track width B determined by the width B of heated fusing element 6 or corresponding to it. In addition, the heated fuser 6 ensures that the substrate band 3 in the area of the melted track 9 is condensed at the melted track 9 by a track depth T that corresponds to the total thickness D of the textile substrate band 3. FIG. 2 shows on the left the consolidated area of the substrate band 3 in the area of the melted track 9. In principle it is also possible that the melted track 9 is not formed through the total thickness D of the textile substrate band 3, but only to a track depth and thus partial thickness T, which however is at least 20% of the total thickness D of the substrate band 3 and extends according to the view in the right in FIG. 2 starting from the heated bar 6 to the opposite face of the substrate band 3.

In this embodiment, the fuser 6 ensures that the melted track 9 is introduced into the substrate band 3 by physical contact therewith, namely with the aid of the heated bar 6 that moves along the substrate band 3 in contact with it. It is also possible that the fuser 6 generates the melted track 9 in the substrate band 3 without contact, as was already described in the description introduction. Furthermore FIG. 2 shows that according to this embodiment the fuser 6 and the slitting blade 8a are fixed to a common stationary support 10 so they are a stationary functional unit 6, 8. Thus, the intermediate sensor 7 is optional.

It is however also possible that the fuser 6 and the slitting blade 8a or the longitudinal slitter 8 are functionally separate from each other. Then the substrate band 3 with the melted tracks 9 is first wound up and in a subsequent following step unwound again and fed to the longitudinal slitter 8. In this case the longitudinal slitter 8 upstream of the sensor 7 ensures that the individual melted tracks 9 are also exactly aligned so individual slitting wheels 8a can cut through the respective melted tracks 9 in approximately the middle.

For this purpose the sensor 7 in this embodiment is connected to a controller 11 that operates an actuator connected to the axle of the supply roll 4 for axial movement as shown at 12 in FIG. 1 to move the substrate band 3 transversely as needed to align the individual melted tracks 9 and the longitudinal slitter 8 or their individual roller cutting wheels 8a. For this purpose, the sensor 7 optically detects the melted track 9. In fact it may be that the sensor 7 is one or several cameras that examine the surface of the textile substrate band 3 or its back face to detect the positions of the melted tracks 9. This is because in the area of the melted track 9 the back face of the textile substrate band 3 has a different surface structure, which for example can be detected via image comparison using the sensor 7 and the controller 11.

Thus, the fuser 6 is heated above the melting point of the substrate band 3. Specifically this means that the temperature of the fuser 6 and according to this embodiment the heated roll 6 are above the melting point of the plastic fibers or filaments that form the textile substrate band 3. In fact one can use for this for example polyester fibers, polyamide fibers etc., to name a few plastics for the plastic fibers. The textile substrate bands that can be processed at this location are expressly not limited. I.e., it can be processed fabric, nonwovens, knitted fabrics, velours as well as mixed forms. As conceivable plastic fibers or plastic filaments, polyester, polyamide, PET, or even PVC or mixtures thereof are used, as long as is guaranteed that the temperature of the fuser 6 exceeds that of the plastic used, so that it in the area of the melted track 9 the fibers and/or filaments forming the textile substrate band 3 are at least partially melted to form the melted track 9 with the track width B and the track depth T. This can in principle be effected without contact by a contactless working fuser 6, which in this embodiment however is not shown.

As material for the fuser 6, materials such as iron or steel, aluminum or copper can be used. Also a fuser 6 made of ceramic or one with a ceramic coating is conceivable in this context, in order to avoid adhesions. As possible ceramic here aluminum nitrite has proven to be particularly favorable. The slitter wheel 8a is in contrast typically made of steel. For the counter roller or counter roller 8b or 6a, one on the other hand resorts to steel or also plastic or rubber as coating of a steel roller. In principle the counter roller 6a, 8b can also be designed entirely as a hardened steel roller.

We claim:

1. A method of making adhesive tape, the method comprising the steps of:
feeding a textile substrate band formed of thermoplastic fibers or filaments from a supply roll in a longitudinal direction;
forming in the band with a fuser at least one longitudinally extending track where the fibers or filaments are melted together and a thickness of the band is reduced; and
cutting the band formed with the tracks into longitudinal strips with a longitudinal slitter having at least one blade longitudinally severing the band at each of the tracks.

2. The method according to claim 1, wherein the fuser and the slitter are fixed to each other.

3. The method according to claim 1, wherein the fuser and the longitudinal slitter are functionally separate from each other.

4. The method according to claim 1, further comprising:
a sensor for detecting the tracks; and
a controller connected to the sensor and relatively positioning the slitter and the band to cut the band centrally in the track.

5. The method according to claim 4, wherein the sensor is optical.

6. The method according to claim 1, wherein the textile substrate band is comprised at least 50% by mass from the thermoplastic fibers or filaments.

7. The method according to claim 1, wherein the fuser forms the melted track in the substrate band with or without contact.

8. The method according to claim 1, wherein the fuser in particular heats the thermoplastic fibers or filaments in the substrate band such that they melt at least in the area of the melted track.

9. The method according to claim 1, wherein the plastic fibers or filaments are fused together by the fuser at least to a partial thickness of the substrate band relative to its total thickness.

10. The method according to claim 1, wherein the fuser is heated above a melting point of the filaments or fibers of the substrate band and generates the melted track by contact with the substrate band.

11. The method according to claim 1, wherein the fuser heats the substrate band above the melting point by electromagnetic radiation and thereby produces the melted track without contact.

12. A method of making adhesive tape, the method comprising the steps of:
feeding a textile substrate band formed of thermoplastic fibers or filaments in a longitudinal direction;
forming in the band with a fuser a plurality of parallel and longitudinally extending tracks where the fibers or filaments are melted together and a thickness of the band is reduced; and
cutting the band formed with the tracks with a longitudinal slitter downstream in the direction from the fuser and having a plurality of blades each longitudinally severing the band at a respective one of the tracks.

13. An apparatus for making adhesive tape using the method of claim 1, the apparatus comprising
means for feeding a textile substrate band in a longitudinal direction;
a heatable fuser for forming in the band at least one longitudinally extending track where a thickness of the band is reduced and the fibers or filaments of the band are welded together; and
a longitudinal slitter having at least one blade for severing the band at the track into a plurality of individual strips.

14. The apparatus according to claim 13, wherein the slitter is downstream in the direction from the fuser.

15. The apparatus according to claim 13, further comprising:
a sensor between the fuser and the longitudinal slitter for aligning the melted track with respect to the blade.

16. An adhesive tape made according to the method of claim 1.

17. Use of an adhesive tape according to claim 16 as wrapping tape for bundling cables in automobiles, wherein the adhesive tape is guided in a spiral or as longitudinal wrap around the cables and is bonded adhesively thereto.
